(19) United States
(12) Patent Application Publication
(10) Pub. No.: US 2016/0359707 A1
(43) Pub. Date: Dec. 8, 2016

(54) SYSTEMS AND METHODS OF COMMUNICATION ON SLIP RINGS AND SLIP RING MONITORING

(71) Applicant: PCN Technology, Inc., San Diego, CA (US)

(72) Inventors: Kyle Martin, Columbia, MO (US); Subramanian Shastri, Carlsbad, CA (US)

(73) Assignee: PCN Technology, Inc., San Diego, CA (US)

(21) Appl. No.: 15/175,123

(22) Filed: Jun. 7, 2016

Related U.S. Application Data
(60) Provisional application No. 62/172,095, filed on Jun. 7, 2015.
(60) Provisional application No. 62/172,106, filed on Jun. 7, 2015.

(51) Int. Cl. H04L 12/26; H04L 27/00; H04L 27/26

(52) U.S. Cl. CPC H04L 43/08; H04L 27/2601; H04L 27/0014; H04L 27/0002

(57) ABSTRACT

Systems and methods of data communication, re-purposing a legacy communications system, and monitoring slip rings are provided. Disclosed systems and methods provide the capability to communicate serial data, Ethernet data or a combination thereof over IP slip rings and/or legacy slip rings. Disclosed systems and methods monitor IP slip rings or legacy slip rings connected to legacy wiring, structured cabling, or a combination thereof for a combination of wear and debris. Exemplary methods of re-purposing a legacy communications system comprise establishing communications interface device including a serial bus-interface on a legacy slip ring, filtering serial data signals and Ethernet data signals through the legacy slip ring, and reducing interference between the serial data signals and Ethernet data signals. Exemplary embodiments include methods of monitoring slip rings comprising determining channel state information of carrier frequencies in at least one communication channel, analyzing the channel state information for changes in properties in the at least one communication channel, and making an assessment of at least one condition of at least one slip ring.

### CROSS-REFERENCE TO RELATED APPLICATIONS

This application is a non-provisional of and claims priority to U.S. patent application Ser. No. 62/172,095, filed Jun. 7, 2015, which is hereby incorporated by reference in its entirety. This application is a non-provisional of and claims priority to U.S. patent application Ser. No. 62/172,106, filed Jun. 7, 2015, which is hereby incorporated by reference in its entirety.

### FIELD

The present disclosure relates to data communication systems and methods.

### BACKGROUND

Slip rings are used in a number of rotating machines such as wind turbines, robots, radar systems, and helicopters and other aircraft to transfer power and data between the rotating and stationary components of the system. Data can be sensor data, instrument data, command and control, or a combination thereof. As a result, factors such as low communication error rates and high communication reliability are key in slip ring deployment and field use.

Traditionally, communication through slip rings has been implemented using a proprietary or standard serial data protocol. More recently, there has been a move from such legacy slip rings using legacy wiring to slip rings that can communicate Ethernet protocol to enable data upload to and data storage in the cloud. These Internet Protocol (IP) slip rings using structured cabling have also enabled operators to deploy web-enabled services for planning and scheduling operations across large facilities such as an entire wind farm.

In recent slip ring applications, communication is typically carried out across slip rings using Ethernet protocol and Orthogonal Frequency Division Multiplexing (OFDM) modulation. Current practice is the use of OFDM for modulation along with methods such as Quadrature Amplitude Modulation for signaling. OFDM, as a technology, requires two constraints to be satisfied to keep BIT error rates small and prevent them from growing with time.

The first is frequency synchronization. This requires that information encoded in a particular carrier (channel) or sub-carrier (sub-channel) can be decoded from the same carrier or sub-carrier. In reality, this constrains the amount of “channel spreading” that is allowable during communication, and the AFEs in the front-end of OFDM products are designed so that channel integrity can be maintained over the specified range of communication on the TX and RX sides. Otherwise, inter-channel interference cannot be held below specified levels at the RX side even with sufficient guard banding at the TX side.

The second constraint is time synchronization, which requires that information be made available in a time synchronized manner with respect to when OFDM modulation is performed. As an example, if an OFDM engine is tied to a sensor, then data from that sensor will be available in a manner that is time synchronous with the modulation engine. Otherwise, BIT error rates will grow with time.

Unfortunately, in industrial and mission-critical use cases, neither frequency synchronization nor time synchronization can be guaranteed for a variety of reasons. Industrial environments are characterized by very high levels of electrical and mechanically-induced noise as well as electromagnetic interference. In addition, as wiring infrastructure age over time, they become susceptible to ground loops and insulation problems. These are often outside the specifications that OFDM modulation chip sets and analog front ends are designed for. Industrial environments also have a preferred wiring topology that is different from point-to-point. In addition to a star topology, multi-drop and daisy chain configurations are common. The impedance characteristics of the physical medium in such configurations as well as the electrical loads presented by connected devices can and do change over time.

Moreover, slip ring, cable or wiring characteristics or a combination thereof change over time due to factors such as wear, collection of debris, temperature cycling, and other natural or man-made environmental factors. Such changes result in degradation of the channel properties of the physical medium representing the cabling, wiring and slip rings.

Slip rings used for power can be monitored for wear or debris accumulation using information such as current supplied by the brushes, rotor speed, mechanical vibrations, or combinations thereof. However, monitoring slip rings used for data is more complicated as the impact of wear and debris are reflected in communication errors which cannot be easily remedied. For this reason, they are rarely monitored in the field, and dealt with by scheduled maintenance.

Accordingly, there is a need for systems and methods of reliable communication of data over slip rings. There is a particular need for systems and methods to communicate serial data, Ethernet data or a combination thereof through IP slip rings or legacy slip rings. There also exists a need for systems and methods that can re-purpose existing legacy cables that do not have the transmission line characteristics of structured cabling and can simultaneously communicate both the existing legacy communication data and newly introduced data through slip rings. There is a need for methods of communicating data through slip rings over ranges beyond Long Reach Ethernet (LRE) while maintaining orthogonality and guaranteeing time synchronization. There is also a need for methods of monitoring the physical medium of slip rings for condition assessment, fault assessment, condition prediction, fault prediction, or a combination thereof.

### SUMMARY

Embodiments of the present disclosure alleviate to a great extent the disadvantages of known communications systems by providing systems and methods of communicating serial data, Ethernet data, or a combination thereof through either legacy slip rings, IP slip rings, or both. More particularly, disclosed systems and methods communicate serial data, Ethernet data or a combination thereof over IP slip rings or legacy slip rings that have been connected using legacy wiring, structured cabling or a combination thereof. Disclosed systems and methods use a filter to facilitate transmission of serial data signals and Ethernet data signals through slip rings such that interference is reduced. Disclosed systems and methods monitor slip ring conditions for slip ring wear and debris collection.

Disclosed systems and methods communicate serial data, Ethernet data or a combination thereof over IP slip rings and/or legacy slip rings that have been degraded by debris. Disclosed systems and methods communicate serial data, Ethernet data or a combination thereof over IP slip rings and/or legacy slip rings that have been degraded by wear. Disclosed systems and methods communicate serial data, Ethernet data or a combination thereof over IP slip rings and/or legacy slip rings that have been degraded by a combination of wear and debris.

Exemplary embodiments of a data communication system comprise at least one communications interface device including a serial bus-interface. The serial bus-interface is configured to communicate serial data signals and Ethernet data signals through at least one slip ring. The at least on slip ring may be a legacy slip ring, an IP slip ring, or at least one legacy slip ring and at least one IP slip ring. The serial bus-interface is configured to facilitate transmission of the serial data signals and the Ethernet data signals such that interference is reduced. In exemplary embodiments, transmission of the serial data signals and the Ethernet data signals is simultaneous. The communications interface device further includes a bridge network management circuit interfacing with one or both of a legacy serial data management circuit and an Ethernet data management circuit.

In exemplary embodiments, the interference is one or more of inter-channel interference and inter-symbol interference. The serial bus-interface may force orthogonality in one or more of the serial data signals and the Ethernet data signals. In exemplary embodiments, the serial bus-interface includes a filter located at an output and forces orthogonality in one or more of the serial data signals and the Ethernet data signals prior to modulation of the signals on a legacy slip ring. The filter may be located at an input and forces orthogonality in one or more of the serial data signals and the Ethernet data signals prior to processing of the signals on a legacy slip ring. The filter may be fixed or changed based on one or more of: performance criteria and constraints.

Exemplary methods of re-purposing a legacy communications system comprise establishing at least one communications interface device including a serial bus-interface on a legacy slip ring, filtering serial data signals and Ethernet data signals through the legacy slip ring, and reducing interference between the serial data signals and Ethernet data signals. Disclosed methods may be employed in a legacy communications system used in one or more of an industrial application and a mission-critical application. In exemplary embodiments, the legacy communications system comprises a combination of synchronous and asynchronous communication. In exemplary embodiments, the filtering facilitates channel spreading. The channel spreading may enable communication over at least Long Reach Ethernet range.

Disclosed methods monitor IP slip rings or legacy slip rings. Disclosed methods monitor IP slip rings or legacy slip rings that are subject to debris. Disclosed methods monitor IP slip rings or legacy slip rings that are subject to wear. Disclosed methods monitor IP slip rings or legacy slip rings that are subject to a combination of wear and debris. Disclosed methods monitor IP slip rings or legacy slip rings connected to legacy wiring, structured cabling, or a combination thereof.

Exemplary embodiments include methods of monitoring slip rings comprising determining channel state information (CSI) of carrier frequencies in at least one communication channel, analyzing the channel state information for changes in properties in the at least one communication channel, and making an assessment of at least one condition of at least one slip ring. The properties may comprise one or more of impedance, signal strength, and noise. The assessment may comprise one or more of condition assessment, fault assessment, condition prediction, and fault prediction. In exemplary embodiments, the at least one condition comprises one or more of slip ring wear and debris collection on the at least one slip ring. In exemplary embodiments, the slip ring is communicatively connected to one or more of the Ethernet and legacy wiring. The determining of the channel state information may be repeated on a regular basis.

Accordingly, it is seen that systems and methods of data communication, re-purposing a legacy communications system, and monitoring slip rings are disclosed. The disclosed systems and methods provide the capability to communicate serial data, Ethernet data or a combination thereof over IP slip rings and/or legacy slip rings. Disclosed systems and methods monitor IP slip rings or legacy slip rings connected to legacy wiring, structured cabling, or a combination thereof for a combination of wear and debris. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a block diagram showing an exemplary embodiment of a data communication system in accordance with the present disclosure;

FIG. 2 is a block diagram showing an exemplary embodiment of a communication interface device for a data communication system in accordance with the present disclosure;

FIG. 3 is a chart showing an exemplary embodiment of CSI in accordance with the present disclosure; and

FIG. 4 is a chart showing an exemplary embodiment of a method of monitoring slip rings in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

Exemplary embodiments of a data communications system re-purpose existing legacy cables that do not have the transmission line characteristics of structured cabling so data can be communicated over long ranges while maintaining orthogonality and guaranteeing time synchronization. Use cases under consideration require communication of data at ranges well beyond LRE. Since range and environmental effects together have a cumulative effect on channel spreading, it cannot be assumed that chip set AFEs will be the required guard banding to guarantee that channels will be orthogonal at the RX side. Advantageously, disclosed systems and methods facilitate significant channel spreading even over LRE distances, unless chip set AFEs are designed for the specific transmission line characteristics in question.

In the extended ranges typical in industrial and mission-critical environments, phase offsets begin to manifest as an issue even in conductive medium communication and can impact frequency synchronization. Time synchronization is even harder to guarantee since all of the timing mechanisms in a typical industrial or mission-critical application would be driven by requirements that are specific to the command and control of the system. When there is simultaneous communication of legacy data and broadband data, the legacy communication may require timing considerations that may be in conflict with time synchronization requirements on the broadband side.

In the event the physical network is shared in any way with safety systems, any ability to enforce time synchronization would be minimal since safety systems operations are highly event based. As a result, even when OFDM chip sets are used for modulation of signal, the communication method used cannot rely on both frequency and time synchronization being present at all times, and must accommodate for both inter-channel and inter-symbol interference.

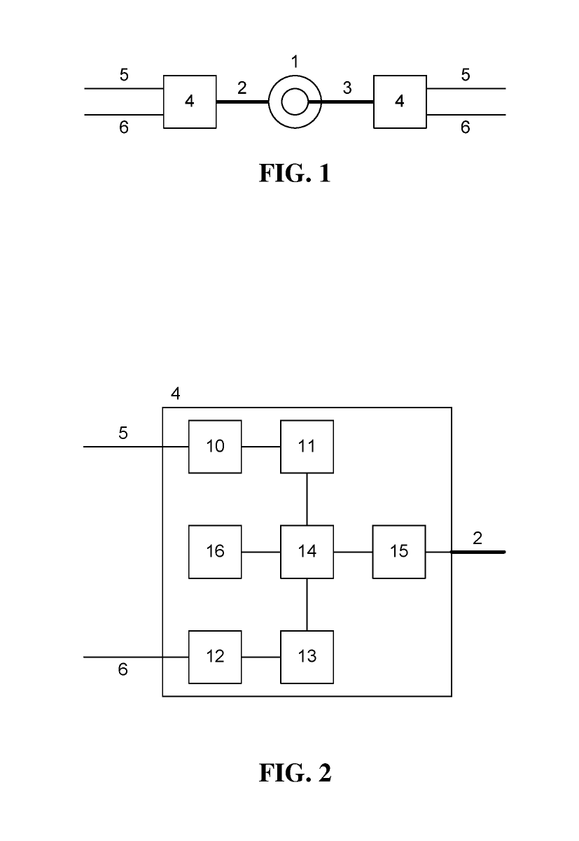

Referring to FIGS. 1 and 2, exemplary embodiments of a data communication system using a slip ring 1 establish a bus 12 on the legacy wiring infrastructure. The bus 12 communicates serial data signals and Ethernet data signals through the slip rings. Advantageously, the bus 12 can simultaneously communicate both the existing legacy communication data and newly introduced data. The slip rings can be legacy slip rings, IP slip rings, or a combination of legacy and IP slip rings.

FIG. 1 is a block diagram showing exemplary architecture of a system communicating serial data and Ethernet data via a slip ring. A communications slip ring 1, which may be a type either transporting legacy serial data communication or Ethernet data communication (IP slip ring) or both, is connected to a communications interface device 4 via either legacy serial wiring 2 or structured cabling 3. The cabling between the slip ring 1 and the interface device 4 can be of varying length and type and can be different types on either side of the slip ring. In exemplary embodiments, the communications interface device 4 comprises of the bus interface circuits, couplers, filters, integrated circuits, software, and other components required to transport simultaneous and asynchronous legacy serial data 5 and Ethernet data 6 over the legacy or structured cabling and the slip ring 1.

The communications interface device 4 may also comprise protocols and procedures for measuring the CSI and using this information to ensure high QoS communication and may use this information to monitor the health of the slip ring 1 or make the information available via some means of communication so that another device or system may monitor the health of the slip ring. The communication interface device 4 could also be interfaced to the slip ring 1 in such a way that it is an embedded component of the slip ring, making the slip ring itself a system for enhanced communication of both legacy serial data and Ethernet data and giving the slip ring the ability for advanced monitoring of its health.

Turning to FIG. 2, a block diagram shows exemplary architecture for the communication interface device 4. In exemplary embodiments, the communication interface device 4 is comprised of a number of sub-systems which provide an interface to the various physical network types, provide protocol management as needed for the various logical network types, facilitate management and multiplexing/demultiplexing of the legacy serial data signals and Ethernet data signals, and provide for CSI measurement and monitoring.

An exemplary serial bus-interface 10 comprises the electrical interface circuitry required for the communication interface device 4 to be compatible with the physical layer of the legacy serial data signals. The serial bus-interface 10 may contain transmitters, receivers, buffers, filters, and couplers as required to achieve the task of interfacing to the legacy serial bus and conditioning the signals for transmission and reception to and from the legacy serial bus and to and from the legacy serial data management circuit 11. In exemplary embodiments, a legacy serial data management circuit comprises circuitry and software which manages the bit-by-bit, byte-by-byte, and/or frame-by-frame legacy serial data to ensure the quality and integrity of the legacy serial data being communicated bi-directionally through the slip ring.

An exemplary Ethernet interface 12 comprises of the electrical interface circuitry required for the communication interface device 4 to be compatible with the Ethernet physical layer. In exemplary embodiments, the Ethernet interface 12 connects to an Ethernet data management circuit 13, such as an embedded Ethernet switch. The combined Ethernet interface and management circuit may have any number of ports equal to or greater than one.

In exemplary embodiments, a bridge network management circuit 14 interfaces to both the legacy serial data management and Ethernet data management circuits. The bridge network management circuit (network manager) is responsible for managing the time domain and frequency domain transmission of the legacy serial data and Ethernet data signals over the legacy serial wiring or structured cabling and through the slip ring 1.

The network manager may be comprised of a network protocol for bridging Ethernet data over a conductive medium (legacy serial wiring or structured cabling) using broadband signaling such as OFDM. The network manager interfaces to the legacy serial wiring or structured cabling and slip ring via a bus-interface circuit 15 which may be comprised of transmitters, receivers, buffers, couplers, and filters and required to transport the complex signaling.

In exemplary embodiments, the network manager combines the broadband bridged Ethernet communication with conditioned base-band signaling which transports the legacy serial data. As discussed in more detail herein, the network manager may also be capable of measuring the CSI by determining the signal to noise ratio of each of the broadband carriers being used. The CSI may optionally be used to manage and improve the QoS of the transmission/reception of either or both of the legacy serial data or Ethernet data. A separate sub-system 16 may be used for measuring the CSI and/or for monitoring the health of the slip ring and/or for management of the CSI to be provided to an external device or system which uses the information for monitoring slip ring health.

In exemplary embodiments, the serial bus-interface includes a filter configured to facilitate transmission of the serial data signals and the Ethernet data signals such that interference is reduced. The filter can be an analog or digital filter. As discussed in more detail herein, the filter may be at different locations in the system and force orthogonality in the signals. This is advantageous because in some systems it may not be possible to guarantee that orthogonality is maintained between the legacy communication channel and the newly introduced communication channel. As an example, when the serial Baud rate gets very high, both the width of the baseband required for the legacy communication, as well as the extent of inter channel interference will be substantial and orthogonality between the legacy communication channel and the broadband channel cannot be guaranteed.

Exemplary embodiments provide both frequency and time synchronization and accommodate for both inter-channel and inter-symbol interference through the use of filters. Filters can be located at the output to force orthogonality in the signal between channels prior to their modulation on the wired infrastructure. Alternatively, filters can be located at the input to force orthogonality prior to processing the multi-channel signal readout from the wired infrastructure. It should be noted that filters can be implemented either in software or in hardware. The filters can be fixed or changed in time or based on various factors including, but not limited to, performance criteria, constraints or a combination thereof.

These Filtered Multi Carrier (FMC) principles have been applied to shared media wireless communication. They have also been generalized as Universal FMC (UFMC) and applied for 5G communication over wireless media. Exemplary embodiments described herein advantageously apply FMC principles to wired infrastructure to reduce inter-channel interference and inter-symbol interference that are specific to use cases found in industrial and mission-critical applications.

It should be noted that there are a number of differences between FMC for wireless and FMC for wired systems. For instance, transmission properties of “air as a medium” and “copper as a medium” have significant differences. As a result, the environmental requirements that drive filter design will be substantially different. Fading and multiple reflections are key issues that drive the design of filters in a wireless system. Changes in channel impedance, cross-talk between wires and ground loops are key issues in wired systems. Also, electrical loads represented by devices are not an issue in wireless systems, but they are extremely important in wired systems. Another significant distinction is that wireless communication typically deals with latencies in the order of a fraction of a second, while wired communication needs to work with latencies that are in the order of a fraction of a millisecond.

In relevant use cases, there is some existing communication already on the wiring infrastructure, whose channel and communication properties cannot be altered. This is not an issue with wireless system in the frequency domain, but in wired systems this is extremely important. Jitter is usually not an important issue in the design of wireless systems. In wired systems, jitter is an extremely important design criterion and unless contained, can cause spurious and false triggers and data in adjacent channels. Finally, in relevant use cases, a combination of synchronous and asynchronous communication is common, and will need to be managed in the same wiring infrastructure. Synchronous communication using wireless is rare, especially where the time scales are small.

Exemplary embodiments include methods of monitoring slip rings. Exemplary embodiments described herein propose to use CSI of the carrier frequencies used in OFDM for the determination of slip wear and debris collection. The result of slip wear may be seen through changes in the impedance properties of the wired infrastructure and will be reflected as an attenuation of the signal strengths in the channel. On the other hand, debris may increase the noise in the channels. Exemplary embodiments will therefore use practices from OFDM to determine CSI, but use the results for the determination of slip ring wear and debris collection in the slip ring.

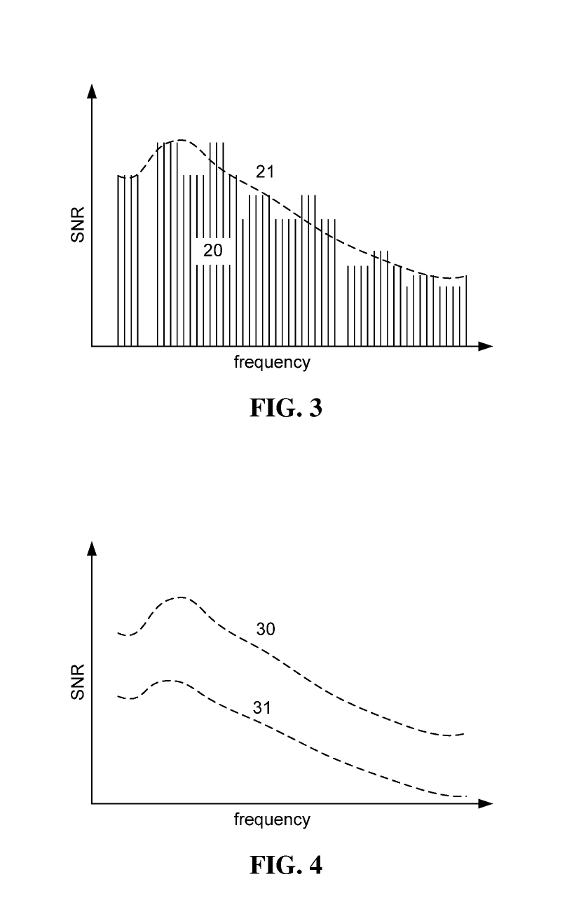

With reference to FIG. 3, a visual representation of exemplary CSI is shown and will be described. In exemplary embodiments, the CSI is measured by the communication interface device. In one implementation, the channel state information is the measured signal to noise ratio (SNR) for each carrier frequency used for communication via the repurposed bus and slip ring. In FIG. 3, this is represented as the collection of signal point measurements of SNR over frequency, visualized as a column graph 20. The CSI, stored as discrete data, could be characterized in an nth degree polynomial, visualized in FIG. 3 as a trending curve 21. The CSI is advantageous for monitoring of the slip ring health.

As illustrated in FIG. 4, the discrete CSI data or the nth degree polynomial characterization are used for monitoring the health of the slip ring in order to provide condition assessment, fault assessment, condition prediction, and fault prediction. Each of these functions is achieved by using either or both the methods of the comparison of the discrete or characterized CSI to a lookup table of pre-determined data trends and/or flags or the comparison of the discrete or characterized CSI to historical values for the same system to determine trends in the change of the CSI. In addition, pre-determined or programmable thresholds could be used in the assessment and/or prediction of conditions and/or faults.

For illustration purposes, FIG. 4 depicts two CSI characterizations: the CSI at install 30 and the current CSI 31. At the moment that the current CSI is measured and characterized, a condition assessment or fault assessment could be determined in one example by comparing the coefficient of each term making up the polynomial to a lookup table and classifying the condition of the slip ring health from the lookup table (for example, as good, fair, or need servicing).

In another example, fault prediction could be made by comparing the integral of the CSI characterization (representing the average SNR over frequency) at install to that of the current CSI. A monitoring algorithm may track the change in the average SNR and determine the rate of change in the average SNR as a function of time. The monitoring algorithm then, either by assuming a constant rate of change or in more advance systems by calculating that the rate of change is not constant, could predict that the average SNR will fall below a certain threshold in some number of days or on a given date. This fault prediction could be used to preemptively schedule maintenance of the slip ring before, but not more frequently than, a failure occurs.

In exemplary embodiments, monitoring the health of one or more slip rings is comprised of determination and analysis of the channel state information. Determination of the CSI may be done on a regular basis. More particularly, the signal-to-noise measurements may be continually or constantly refreshed. This advantageously allows for continuous compensation, rather than existing approaches that make a measurement just one upon initialization. Disclosed systems and methods operate more successfully with such continuous encoding and decoding and enable use in a non-power line environment with continuously changing noise parameters.

In addition to using the CSI for monitoring slip rings, the CSI may also be used for adaptive bit-loading. More particularly, the modulation scheme for each carrier may be selected based on the SNR of the carrier as determined by the CSI. This method advantageously allows communication to continue through the slip ring even as the communication channel changes as the slip ring experiences wear, collects debris, etc. Such use of adaptive bit-loading advantageously maintains effective communication through one or more slip rings.

Thus, it is seen that communications systems and methods are provided. It should be understood that any of the foregoing configurations and specialized components or may be interchangeably used with any of the apparatus or systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the disclosure.

What is claimed is:

1. A data communication system comprising:
at least one communications interface device configured to communicate serial data signals and Ethernet data signals through at least one slip ring;
the communications interface device including a serial bus-interface configured to facilitate transmission of the serial data signals and the Ethernet data signals such that interference is reduced.

2. The system of claim 1 wherein transmission of the serial data signals and the Ethernet data signals is simultaneous.

3. The system of claim 1 wherein the at least one slip ring is a legacy slip ring.

4. The system of claim 1 wherein the at least one slip ring is an IP slip ring.

5. The system of claim 1 wherein the at least one slip ring comprises at least one legacy slip ring and at least one IP slip ring.

6. The system of claim 1 wherein the communications interface device further includes a bridge network management circuit interfacing with one or both of a legacy serial data management circuit and an Ethernet data management circuit.

7. The system of claim 1 wherein the serial bus-interface forces orthogonality in one or more of the serial data signals and the Ethernet data signals.

8. The system of claim 7 wherein the serial bus-interface includes a filter located at an output and forces orthogonality in one or more of the serial data signals and the Ethernet data signals prior to modulation of the signals on a legacy slip ring.

9. The system of claim 7 wherein the serial bus-interface includes a filter located at an input and forces orthogonality in one or more of the serial data signals and the Ethernet data signals prior to processing of the signals on a legacy slip ring.

10. The system of claim 1 wherein the serial bus-interface includes a filter that is fixed or changed based on one or more of: performance criteria and constraints.

11. A method of re-purposing a legacy communications system, comprising:
establishing at least one communications interface device including a serial bus-interface on a legacy slip ring;
filtering serial data signals and Ethernet data signals through the legacy slip ring; and
reducing interference between the serial data signals and Ethernet data signals.

12. The method of claim 11 wherein the legacy communications system is used in one or more of an industrial application and a mission-critical application.

13. The method of claim 11 wherein the legacy communications system comprises a combination of synchronous and asynchronous communication.

14. The method of claim 11 wherein the filtering facilitates channel spreading.

15. The method of claim 14 wherein the channel spreading enables communication over at least Long Reach Ethernet range.

16. A method of monitoring slip rings, comprising:
determining channel state information of carrier frequencies in at least one communication channel;
analyzing the channel state information for changes in properties in the at least one communication channel; and
making an assessment of at least one condition of at least one slip ring.

17. The method of claim 16 wherein the properties comprise one or more of:
impedance, signal strength, and noise.

18. The method of claim 16 wherein the assessment comprises one or more of:
condition assessment, fault assessment, condition prediction, and fault prediction.

19. The method of claim 16 wherein the at least one condition comprises one or more of: slip ring wear and debris collection on the at least one slip ring.

20. The method of claim 16 wherein the determining of the channel state information is repeated on a regular basis.
